(19) United States
(12) Patent Application Publication
(10) Pub. No.: US 2004/0193538 A1
(43) Pub. Date: Sep. 30, 2004

(54) Receipt processing system and method

(76) Inventor: Walter L. Raines, Houston, TX (US)

Correspondence Address: KENNETH L. NASH, P.O. BOX 680106, HOUSTON, TX, 77268-0106, US

(21) Appl. No.: 10/628,819

(22) Filed: Jul. 28, 2003

Related U.S. Application Data
(60) Provisional application No. 60/459,137, filed on Mar. 31, 2003.

(51) Int. Cl. G06F 17/60

(52) U.S. Cl. 705/39

(57) ABSTRACT

The present invention provides a system and method for retrieving a copy of an original receipt by merchants to avoid chargebacks on legitimate sales. In a preferred embodiment, a receipt is printed that contains machine-readable information, such as bar codes or other suitable machine-readable information. The receipt is scanned to provide an electronic copy that is stored in one or more memories. The receipt is retrievable by use of the machine-readable information that may include credit card number, date, amount, and the like. In one preferred embodiment, the stored information is made available through a website to the purchaser who can obtain online a copy of the receipt to thereby avoid the time and cost of unnecessary chargebacks. In another preferred embodiment, a processor handles the chargeback inquiry so the merchant does not need to respond to chargeback inquiry requests.

Benefit is hereby claimed for U.S. Provisional Patent Application No. 60/459,137, filed Mar. 31, 2003, to the inventor hereof.

### TECHNICAL FIELD

The present invention relates generally to a ticket capture device, and more particularly relates to systems and methods for digitizing and recovering receipt data, e.g., a sales receipt in conjunction with a financial transaction.

### BACKGROUND ART

Over the last 20 years, credit cards have gained widespread acceptance as a means of paying for goods and services. American consumers presently use credit cards to spend in excess of hundreds of billions of dollars annually. Worldwide, the value of credit card transactions is several times that much.

The large volume of credit card transactions requires merchants to collect, transmit, and store vast amounts of transaction related data to avoid chargebacks. Generally, if merchants do not have adequate records, or are unable to access a receipt for any particular purchase quickly and with low cost, then they are subject to having charges reversed anytime a consumer disputes a charge, as discussed in more detail hereinafter.

It has been reported that merchants may lose up to five percent of chargeback disputes because the paper work involving the chargeback is lost at one location or another. In these cases, the merchant does not even have the option of looking up receipts prior to having the charges reversed. The losses to one large merchant due to lost paperwork regarding chargebacks may be in the millions of dollars per year.

From another perspective, consumers or purchasers who receive debits on their credit card statements often have very little information to go by other than personal recollection to determine whether or not the purchase is genuine. Generally, consumers must rely on their own memory of the store name (assuming this is provided) or the city or date on the credit card statement to determine whether the transaction is valid or not. In many cases, consumers share cards with other family members or with an organization. In some cases, such as the military, businesses, or other large government agency, where a great deal of purchases are made via credit card, it is a time consuming and costly task for an accounting department to determine whether each charge is properly authorized or not and what the underlying goods comprises. For purchasers, businesses, and government agencies, determining whether the charges comprise valid costs requires substantial amounts of time, i.e., money. Moreover, to the extent chargeback investigations are launched, additional time is spent by the merchants, purchasers, accounting departments, consumers, credit card companies, and/or other groups, as discussed below.

As used herein, the term “credit card” is intended to include credit cards, charge cards, debit cards, and other financial account cards. Credit cards typically include two sources of essential account information. A magnetic stripe includes the account number, expiration date, cardholder's name, and other information. Embossed characters also provide the account number, expiration date, and cardholder's name in a form that may be recognized by a merchant.

In order for a credit card transaction to be processed, a merchant must collect a variety of data associated with the transaction. This data typically includes the purchase price and date of the transaction, the account number and expiration date of the credit card, and the cardholder's name and signature. Once this data is collected, the merchant transmits the transaction data, along with its merchant identification code, to a credit card transaction processor. The credit card processor sorts the data according to the company that issued the credit card, and forwards the data to the appropriate company. At that point, the credit card issuer posts the transaction to the cardholder's account and the purchase amount is credited to the merchant.

The credit card processor facilitates the flow of information and finds between merchants and credit card issuers. Formerly, credit card transaction data was recorded, transferred, and stored in the form of paper receipts. Over the years, the credit card industry has developed various types of equipment that provide for the electronic acquisition, transmission, and storage of transaction data. In addition to reducing the industry's reliance on paper records, this equipment expedites the processing of credit card transactions and minimizes errors associated with the entry of transaction data. The equipment includes point-of-sale (POS) equipment used by merchants and computer systems used by credit card processors.

Most merchants normally employ a cash register system of some type in order to record data associated with transactions, regardless of whether payment is made with cash, check, or credit card. In addition to a cash register, merchants that accept credit cards may use other POS equipment to collect data associated with the credit card. This equipment may include electronic terminals that read the account number and expiration date from a magnetic stripe on the credit card and transmit the transaction data to the credit card processor. Such equipment may be separate from, or integrated into, the cash register equipment.

In a typical credit card transaction, a cardholder presents a credit card to a merchant, who records transaction data using an electronic terminal. The recorded data includes the amount of the purchase, the cardholder's account number, the card's expiration date, the merchant identification number, and the date of the transaction. In most cases, the cardholder is also required to sign a copy of the receipt.

Once the terminal accumulates the transaction data, the terminal automatically dials the merchant's credit card processor or other authorization source and initiates an authorization request. When the transaction is authorized, the terminal displays and/or stores the approval code or authorization indicia received from the credit card processor. The approval code is recorded along with the other transaction data. The POS equipment typically includes a printer that is capable of printing a sales receipt. The sales receipt includes the transaction data and approval code, and provides a space for the cardholder's signature.

These prior art devices allow numeric data, such as purchase price, date, account number, and merchant identification number to be easily accumulated, stored, and transmitted between the merchant and credit card processor. Consequently, numeric transaction data may be transferred and stored without the use of paper receipts.

However, in the event a cardholder questions or denies the legitimacy of a transaction that appears on his or her credit card statement, it may be necessary for the merchant to produce a copy of the signed receipt as evidence that the cardholder was indeed a party to the transaction. Along with a notice of a possible chargeback, the merchant is provided with the credit card number, date of transaction, and amount of transaction. Therefore, it is necessary that a copy of each signed receipt be retained by the merchant for some period of time, e.g., 18 months for the IRS and 9-12 months for Visa/Mastercard.

POS equipment is sometimes utilized that allows the cardholder's signature to be digitized, and stored. If desired, the digitized signature can then be selectively electronically matched to data, such as the numeric data associated with a transaction to make up a signed ticket. A very significant problem with this technology is that the stored signature can be used on other or more transactions than the one it was intended for. In other words, with this type of technology, it is quite possible for someone with access to the database to have the digitized signature associated with any purchase in order to avoid the loss of the sale. Thus, there is considerable concern about data manipulation. The data is often stored at a company office where tickets are reproduced and mailed or faxed to the processor.

Prior art signature capture devices, such as digitizers, also have many technical problems. For instance, if the digitizer is sensitive enough to respond to light writing pressure, it also is likely to respond to coincident finger contact that occurs when a customer is signing a receipt. Decreasing the sensitivity in order to avoid responses to finger contact results in increased writing force being required for the signature. Consequently, the digitizer may fail to capture light handwriting strokes. Moreover, wear from repeated use damages the coated surfaces and leads to position errors in the digitized signals. Generally, wear is a significant problem that eventually results in many very poorly digitized signatures to the point where the signature is not recognizable. Furthermore, pressure sensitive digitizers do not accurately capture signatures when thick or multi-page forms are used. These systems tend to be expensive, require considerable expertise to install and maintain, and normally require a company to install a large amount of expensive new equipment. Especially, for small businesses, the cost of such updates may not be recovered for many years, if ever. The screens on the digitizers frequently need replacement.

Many merchants have invested significant amounts of money in POS equipment, such as sophisticated electronic cash registers, that allows the merchant to collect all of the numeric data associated with credit card transactions. In the case of larger merchants, the POS equipment may be connected to a merchant's accounting computer system or “in-store processor” via a data communications network in order to facilitate the merchant's business operations. Furthermore, a merchant's existing POS equipment may be connected to peripheral devices, such as check readers for automatically reading checking account data and PIN pads, which are used to input a debit card user's personal identification number (PIN). The existing POS equipment may not provide sufficient communications ports to allow the merchant to connect additional peripheral devices.

Moreover, prior art systems do not take into account paper receipts that already exist in large numbers. The prior art systems may take a significant amount of time (many months) before they acquire the required receipt backup. In some cases, the customer may feel that the transaction data is not correctly associated with the signature. Except to argue that the equipment is working properly and that no errors occurred in the software, the merchant has no real visual proof that the signature captured is even correctly associated with the particular sales information.

The following patents show prior art attempts to solve the above and related problems. The descriptive wording of the patents listed below is taken from the patent abstracts and is therefore limited by the accuracy thereof.

U.S. Pat. No. 4,328,544, issued May 4, 1982, to Balwin et al., discloses a standalone point-of-sale terminal in a unitary physical package that has input/output devices for communicating transaction data between the terminal and an operator, and also has a cash drawer. These devices and a direct-access storage are controlled by a programmable processor which executes low-level routines from read-only addressable memory and serially replaceable high-level applications programs from read/write addressable memory. Both applications programs and transaction data are stored on a single non-volatile, removable storage medium.

U.S. Pat. No. 4,594,663, issued Jun. 10, 1986, to Nagata et al., discloses a credit transaction processing system that processes data related to a commodity entered into by using a card owned by a customer and a recording card owned by a store. First, merchant transaction data necessary for a credit sale stored in the recording medium, such as account number data for the store, data specifying a credit company, and data representing an upper limit of an amount to be sold through a credit sale, are read by a card reader, and then, customer transaction data stored in the customer's recording card, such as account number data of the customer, data specifying a credit company and an identification number or code is read. If and when the customer enters his identification number by a ten-key, a central processing unit determines whether the entered identification number coincides with the identification number read out of the customer's card. If and when a coincidence occurs, it is determined whether data indicating the purchase price of the commodity purchased by the customer is lower than the upper limit of the amount to be sold through a credit sale. If so, the price data is transmitted to a center station and the amount of the money required for the credit sale is transferred from the bank account of the credit company utilized by the customer to the bank account of the store.

U.S. Pat. No. 5,019,694, issued May 28, 1991, to Donald A. Collins, Jr., discloses an overhead bar code scanning system that is supported by a checkout counter and includes an overhanging portion to which is secured a plurality of scanning units orientated towards the counter to scan a coded label on a merchandise item moved under the scanning units. Mounted in the overhanging portion are a pair of display members, a pair of keyboard members, a printer and a magnetic stripe reader for use by the operator and the customer to process the purchased merchandise items.

U.S. Pat. No. 5,278,396, issued Jan. 11, 1994, to Jerry A. McGaha, discloses a printer slip table which employs a laser scan module in combination with a printer to expedite checkout and return of merchandise articles. The scan module may be employed to scan bar code labels on slips attached to the articles, coupons, and previous receipts for return articles. The printer may be a single printer or a plurality of specialized printers. The printer prints receipts, voids coupons by printing seller information thereon, and prints journals. The printer may additionally print buyer information on coupons and return information on receipts, slips, and journals. Return information, such as purchase date and location, may be encoded as a bar code label to be scanned upon return.

U.S. Pat. No. 5,428,210, issued Jun. 27, 1995, to Nair et al., discloses a data card terminal, such as a credit card transaction terminal. The terminal includes a transaction terminal comprising an embossed character reader and magnetic stripe reader, with a separate signature capture printer. The transaction terminal is operative for detecting the physical presence of a data card during a card transaction. The embossed character reader employs a tactile imager and pattern recognition for detecting the embossed characters on the data card. A signature capturing printer prints a paper receipt, which is signed by a cardholder at a signature capturing window on the printer. A signature capturing system digitizes and compresses signals corresponding to the signature of the card holder. Transaction data including compressed signature signals and signals indicative of the presence of the card are transmitted to the host computer system of a transaction processor, who guarantees the transaction as chargeback-protected under certain circumstances. Also disclosed are methods for operation of the terminal, and methods for operation of transaction processor systems responsive to signals from the terminal, such as providing chargeback protected transactions and providing electronic and off-line transaction authorizations.

U.S. Pat. No. 5,432,326, issued Jul. 11, 1995, to Noblett, Jr., et al., discloses systems and methods for operating a data card terminal, such as a credit card transaction terminal, for providing chargeback protection services for the benefit of merchants. The terminal includes a transaction terminal comprising an embossed character reader and magnetic stripe reader, with a separate signature capture printer. The transaction terminal is operative for detecting the physical presence of a data card during a card transaction. The embossed character reader employs a tactile imager and pattern recognition for detecting the embossed characters on the data card. A signature capturing printer prints a paper receipt, which is signed by a cardholder at a signature capturing window on the printer. A signature capturing system digitizes and compresses signals corresponding to the signature of the card holder. Transaction data including compressed signature signals and signals indicative of the presence of the card are transmitted to the host computer system of a transaction processor, who guarantees the transaction as chargeback-protected under certain circumstances. Also disclosed are methods for providing electronic and off-line transaction authorizations.

U.S. Pat. No. 5,448,044, issued Sep. 5, 1995, to Price et al., discloses a signature capture pad (or signature capture/PIN pad) operative for gathering signature data associated with customer transactions includes a digitizer, microprocessor, and a plurality of serial ports, and may be connected to a point-of-sale (POS) terminal, such as an electronic cash register. The signature capture pad provides compressed or uncompressed signature signals in response to commands received from the POS terminal. Uncompressed signature data may be used to provide a facsimile signature on a display or printer at the POS terminal, whereby the signature may be approved by the operator. A signature capture cycle is terminated upon receipt of a command from the POS terminal, or upon the expiration of an optional timer. The maximum size of the compressed signature data is selectable by the POS terminal. Compressed signature data exceeding the prescribed size may be post-processed at a lower resolution. The signature capture pad includes a plurality of serial communications ports that allow the signature capture pad to be connected in series between POS terminal and a peripheral device. The terminal is operative to intercept and respond to serial data, or to reroute serial data between any of the serial ports. The terminal is especially suitable for use in a system wherein chargeback protection is to be afforded to certain transactions in the event that signature signals are combined with other transaction information and forwarded electronically to a transaction processor or guarantor.

U.S. Pat. No. 5,479,530, issued Dec. 26, 1995, to Nair et al., discloses a data card terminal, such as a credit card transaction terminal. The terminal includes a transaction terminal comprising an embossed character reader and magnetic stripe reader, with a separate signature capture printer. The transaction terminal is operative for detecting the physical presence of a data card during a card transaction. The embossed character reader employs a tactile imager and pattern recognition for detecting the embossed characters on the data card. A signature capturing printer prints a paper receipt, which is signed by a cardholder at a signature capturing window on the printer. A signature capturing system digitizes and compresses signals corresponding to the signature of the card holder. Transaction data including compressed signature signals and signals indicative of the presence of the card are transmitted to the host computer system of a transaction processor, who guarantees the transaction as chargeback-protected under certain circumstances. Also disclosed are methods for operation of the terminal, and methods for operation of transaction processor systems responsive to signals from the terminal, such as providing chargeback protected transactions and providing electronic and off-line transaction authorizations.

U.S. Pat. No. 5,502,576, issued Mar. 26, 1996, to Ramsay et al., discloses a method and apparatus for high speed conversion of tangible source documents to electronic images, and subsequent transmission or storage and retrieval of images, utilizing hybrid signal processing. The system employs a higher bandwidth analog signal for image capture and lower effective bandwidth analog signal for transmission or storage and retrieval, with an intervening digital memory utilized to construct a bitmap of the image to facilitate various dissection and seaming schemes which optimize image content and processing time. The system is designed around a conventional bus structure, and the memory serves as a junction with conventional personal computers, networks, and peripheral devices. In a representative embodiment, a tangible image is captured using a camera producing an analog signal with conventional raster synchronization. The synchronization is stripped from the analog signal, which is digitized for 8-bit grayscale and multiplexed to the memory where the image exists as a bitmap that may be divided into segments. The content is read from the memory, converted to an analog signal, and control signals are added. The control signals include horizontal and vertical sync pulses and interval blanking, a pilot signal to maintain alignment between adjacent segments along seams and to compensate for time-based errors, and calibration pulses to permit instantaneous adjustment of the gray level for each line, ensure accurate image content, and permit display enhancement. The resultant analog signal is stored on a randomly accessible storage medium as one or more frames, transmitted and reassembled, or displayed on a conventional monitor.

U.S. Pat. No. 5,659,469, issued Aug. 19, 1997, to Deaton et al., discloses an automatic check reading technique which enables the detection of a customer's checking account number on a check, regardless of the bank, bank branch or type of account. The customer identification code is automatically used to provide check verification as well as to provide various targeted marketing techniques based upon the customer's prior transactional history with the store.

U.S. Pat. No. 5,910,988, issued Jun. 8, 1999, to Claudio R. Ballard, discloses a system for remote data acquisition and centralized processing and storage called the DataTreasury.™. System. The DataTreasury.™. System provides comprehensive support for the processing of documents and electronic data associated with different applications including sale, business, banking and general consumer transactions. The system retrieves transaction data at one or more remote Locations, encrypts the data, transmits the encrypted data to a central location, transforms the data to a usable form, performs identification verification using signature data and biometric data, generates informative reports from the data and transmits the informative reports to the remote location(s). The DataTreasury.™. System has many advantageous features which work together to provide high performance, security, reliability, fault tolerance and low cost. First, the network architecture facilitates secure communication between the remote location(s) and the central processing facility. A dynamic address assignment algorithm performs load balancing among the system's servers for faster performance and higher utilization. Finally, a partitioning scheme improves the error correction process.

U.S. Pat. No. 6,032,137, issued Feb. 29, 2000, to Claudio R. Ballard, discloses a system for remote data acquisition and centralized processing and storage called the DataTreasury.™. System. The DataTreasury.™. System provides comprehensive support for the processing of documents and electronic data associated with different applications including sale, business, banking and general consumer transactions. The system retrieves transaction data such as credit card receipts checks in either electronic or paper form at one or more remote locations, encrypts the data, transmits the encrypted data to a central location, transforms the data to a usable form, performs identification verification using signature data and biometric data, generates informative reports from the data and transmits the informative reports to the remote location(s). The DataTreasury.™.

U.S. Pat. No. 6,289,460 B1, issued Sep. 11, 2001, to Mir Hajmiragha, discloses a system for allowing predesignated users at remotely located computer-based systems to perform document management. Components of the system include public data network, a publication facility, a remote storage facility and a document manager computer-based system. The document manager computer-based system, the publication facility, the remote storage facility are all coupled to the computer-based systems used by the predesignated users over the public data network. The system allows authorized users from remote locations to perform secure document collaboration, share and archive documents, context index documents, digitally notarize documents, electronically file documents and publish documents.

U.S. Pat. No. 6,397,194 B1, issued May 28, 2002, to Houvener et al., discloses a transaction data processing system and method, which is especially configured to capture, store and retrieve transaction data, including a digital representation of a signature of a person initiating a transaction. The transaction data processing system includes a scanner located at a point of use location. The scanner is configured to scan a transaction document including the signature of at least one party to the transaction. A transaction data processor is also included for processing the scanned transaction data and for generating a transaction data record. A remote database site having stored therein a database of transaction data records is also provided. A communications link links the remote database site to the transaction data processor, which is located at the point of use location. The method includes the steps of: scanning a document related to a financial transaction, said document at least a signature of at least one party to the transaction; processing the scanned document and generating a transaction data record; linking the transaction data processor to a remote database site; transmitting each generated transaction data record to the remote database site; and storing each transmitted transaction data record in a transaction data record database.

International Publication No. WO 00/75884 A1, published Dec. 14, 2000, to Houvener et al., discloses a transaction data processing system and method, which is especially configured to capture, store and retrieve transaction data, including a digital representation of a signature of a person initiating a transaction. The transaction data processing system includes a scanner located at a point of use location. The scanner is configured to scan a transaction document including the signature of at least one party to the transaction. A transaction data processor is also included for processing the scanned transaction data and for generating a transaction data record. A remote database site having stored therein a database of transaction data records is also provided. A communications link links the remote database site to the transaction data processor, which is located at the point of use location.

International Application No. WO 01/37107, published May 25, 2001, to Gatto et al., discloses a compact transactional document-scanning terminal. The compact transactional document-scanning terminal may be configured to respond to various customer specifications. For some forms of documents, an image analysis is immediately performed subsequent to the scan in order to extract all or part of the printed information, apply recognition algorithms to encode information and complete automatically the transaction without further human intervention.

The above patents have problems themselves as discussed hereinbefore and do not disclose solutions therefore. Consequently, those of skill in the art will sense the importance of the present invention which addresses the above and other long felt but presently unsolved problems.

### SUMMARY OF THE INVENTION

An objective of the present invention is to provide an improved ticket processing system and method.

Another objective of the present invention is to provide a ticket processing system which may be quickly installed, updated, and/or removed without interruption to existing point of sale (POS) equipment.

Another objective of the present invention is to eliminate merchant losses due to lost paperwork involving chargeback inquiries.

Another objective of the present invention is to eliminate the need for a merchant to become involved in the chargeback inquiry thereby saving the merchant significant overhead costs.

These and other objectives, features, and advantages of the present invention will become apparent from the drawings, the descriptions given herein, and the appended claims. However, it will be understood that the above-listed objectives of the invention are intended only as an aid in understanding aspects of the invention, and are not intended to limit the invention in any way, and therefore do not form a comprehensive or restrictive list of objectives, and/or features, and/or advantages of the invention.

Accordingly, the present invention may provide a method for processing a plurality of credit card financial transactions by a plurality of purchasers. The method may comprise one or more steps such as, for instance, producing a plurality of paper receipts related to the plurality of credit card financial transactions such that each of the plurality of paper receipts comprises machine-readable data which identify each of the plurality of credit card financial transactions and that each of the plurality of paper receipts comprises an endorsement, such as a signature, by a respective of the plurality of purchasers to confirm each of the plurality of credit card financial transactions. Other steps may comprise optically scanning each of the plurality of paper receipts for producing an electronic representation of each entire paper receipt, including the endorsement, and for reading the machine-readable data on the paper receipt and/or electronically storing the electronic copy of the paper receipt so as to be organized for electronic retrieval based on the machine-readable data.

In one embodiment, the machine-readable data comprises bar codes. However, the machine-readable data might also or in the alternative comprise textual print readable by optical character recognition (OCR) software.

The method may, if desired, further comprise providing credit card transaction information over the Internet to the plurality of purchasers. In this case, the credit card transaction information may comprise the electronic copy of the paper receipt.

The method may preferably comprise printing the paper receipt with a printer operable for providing the machine-readable data on the paper receipt.

The endorsement may comprise a signature, or other indication individual to the purchaser to indicate the purchase is genuine.

In another embodiment, a method is provided that may comprise one or more steps such as, for instance, producing a plurality of receipts related to the plurality of credit card financial transactions such that each of the plurality of receipts comprises an endorsement by a respective of the plurality of purchasers to confirm each of the plurality of credit card financial transactions and/or electronically storing an electronic copy of each the plurality of receipts. In a preferred embodiment, the electronic copy is suitable for producing a purchaser-readable copy of a respective of the plurality of receipts. Other steps may comprise providing a web connection such as a web site for use via Internet connection accessible by the plurality of purchasers or agents thereof. The web site may provide credit card transaction information regarding transactions made by the plurality of purchasers during a selected time period. The web site is preferably operable for providing a viewable copy of the respective of the plurality of receipts for a selectable credit card transaction.

In one embodiment, the plurality of receipts so provided is at least originally a paper receipt. The plurality of paper receipts comprise financial transaction data such as the items purchased.

In yet another embodiment, a method for processing a plurality of credit card financial transactions by a plurality of purchasers may comprise electronically storing receipt data related to the plurality of credit card financial transactions such as data comprising the underlying items purchased, and/or providing a web site for use via Internet connection accessible by the plurality of purchasers or agents thereof, the web site providing credit card transaction information made by the plurality of purchasers during a selected time period such that the web site is preferably operable for providing a viewable copy of the receipt data for a selectable of the plurality of credit card transactions.

The present invention also provides a system for processing a plurality of credit card financial transactions by a plurality of purchasers which may comprise one or more elements such as, for instance, a printer operable for producing a paper receipt related to the plurality of credit card financial transactions such that each of the plurality of paper receipts comprise machine-readable data which identify each of the plurality of credit card financial transactions, each of the plurality of paper receipts being endorsed by a respective of the plurality of purchasers to confirm each of the plurality of credit card financial transactions, and/or an optical scanner for producing an electronic representation of the plurality of paper receipts including the endorsement, the optical scanner being operable for reading the machine-readable data on the paper receipt, and/or electronic storage medium for storing the electronic representation of the paper receipt, and/or a computer for organizing storage in the electronic storage based on the machine-readable data, the computer being operable for retrieving a selected electronic representation of the paper receipt based on the machine-readable data.

The system may further comprise a website to provide credit card transaction information over the Internet to the plurality of purchasers wherein the credit card transaction information may comprise the electronic copy of the paper receipt.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a block diagram schematic showing one possible embodiment of a ticket processing system that may be utilized in a stand-alone environment in accord with one possible embodiment of the present invention;

FIG. 2 is an elevational view of a presently preferred receipt with machine-readable indicia in accord with one embodiment of the present invention; and

FIG. 3 is a block diagram schematic showing one possible embodiment of a receipt processing system wherein consumer purchase information is retrievable through an Internet connection in accord with one embodiment of the present invention.

FIG. 4 is a flow diagram schematic showing information flow between entities involved in a chargeback inquiry in accord with one embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION AND PREFERRED MODES FOR CARRYING OUT THE INVENTION

The present invention provides a low cost and rapid ticket retrieval system that may be utilized in conjunction with other POS equipment or on a stand-alone basis. The relative low-cost, low maintenance, and easy installation, of one preferred embodiment of the system will return the cost and relatively light installation labor involved within a short time for a merchant that is likely to be subject to chargebacks by providing the capability of quick retrieving a copy of the original invoice with the purchaser's signature shown thereon. Since the copy will appear as the original, additional markings and the like may be stamped on the copy of the original invoice to prevent improper usage thereof.

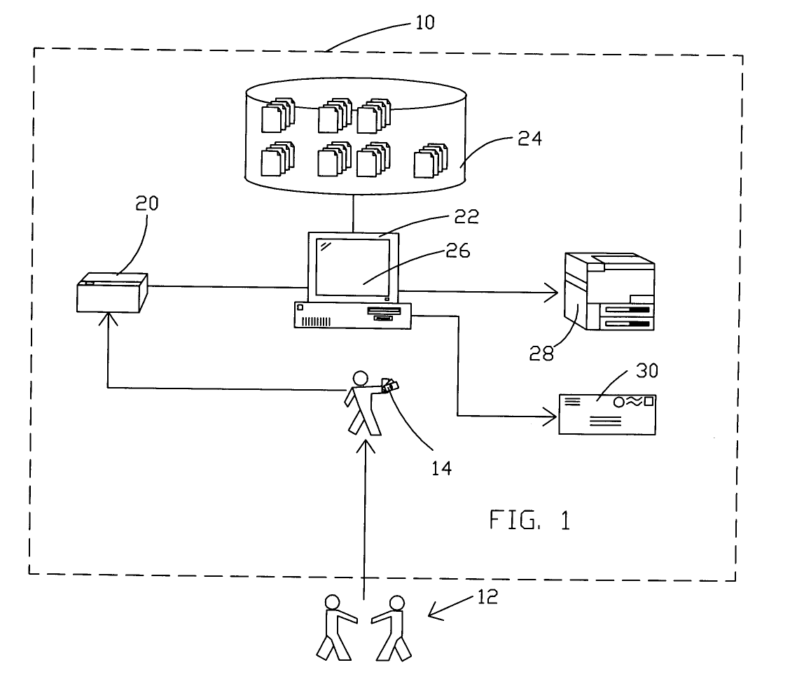

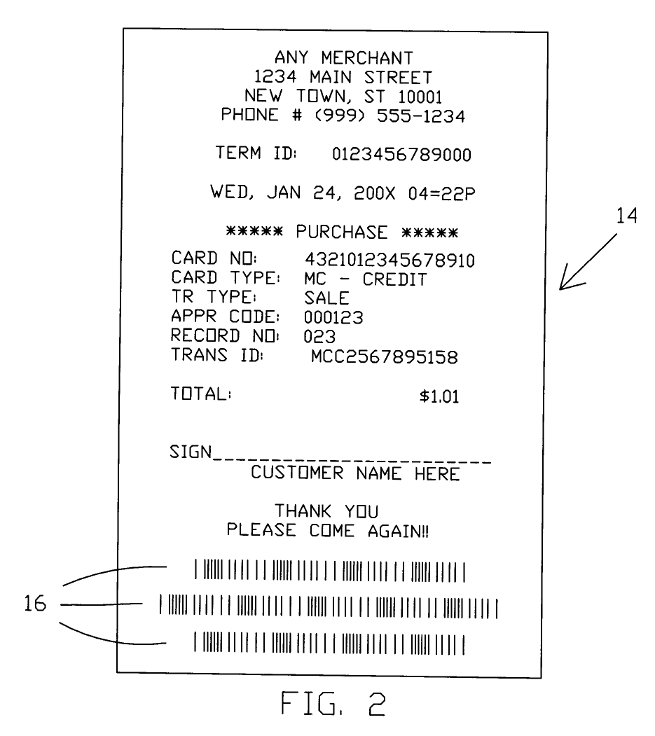

Referring now to the drawings and, more particularly, to FIG. 1, there is shown system 10 in accord with one embodiment of the invention. A credit card transaction occurs at 12 for a sales product or service between a merchant and a purchaser. A paper receipt, such as paper receipt 14 shown for example in FIG. 2, is printed by the merchant's printer and is signed by the purchaser. In a preferred embodiment, and referring again to FIG. 2, the merchant's printer is programmed to produce a machine readable code, such as bar code 16. The machine-readable code, such as bar code 16, comprises information about the transaction such as, for example, the merchant number, the credit card number, the amount of the purchase, and the date of the purchase. This machine readable information is then used to index or organize a scanned copy of receipt 14 in a database as discussed hereinafter.

While a bar code, such as bar code 16, or other easily machine readable information is preferred, the present invention could also utilize optical character recognition (OCR) software to obtain the indexing information. OCR can be especially accurate when the format of the receipt is known and the same type of reasonable resolution print is used consistently. Other means for identification such as bar code labels and the like could also be utilized but would require some additional, but relatively simple, labor. The purchaser obtains a paper copy of the original receipt that includes the purchaser's signature.

In the embodiment of system 10 shown in FIG. 1, the merchant takes the original signed paper credit card receipt, as indicated at 18, to optical scanner 20. The paper receipts are then optically scanned. In many stores, the scanning may be accomplished when the merchant is not busy helping customers so that no additional overhead is required. The scanning may also be accomplished by stacking the receipts in a sheet feeder, whereby the process is largely automated. Thus, any additional labor involved in scanning may be insignificant and will typically be largely or completely absorbed into the already existing overhead.

However, the present invention could also be built into POS equipment and depending on the desired level of complexity of equipment, optical scanner 20 could be in the feed path of the printer so that the paper receipt is automatically scanned. Moreover, if the system is built into the POS equipment, then it is not necessary to print the bar code or other machine readable information onto the paper receipt, since the credit card number and sales data are already known.

In the embodiment shown in FIG. 1, scanner 20 is preferably operated by programming of computer 22 to read the desired machine-readable information and simultaneously form an electronic representation or image. Thus, in a preferred embodiment only one scan of paper receipt 14 is required. After scanning, computer 22 now has an image to be stored and indexing information such as the credit card number, date, sales amount, and the like, for organizing the electronic image of paper receipt 14 in memory 24. Memory 24 may comprise any memory on or off location and may also comprise backup memory. For instance, memory 24 may comprise memory in computer 22 and/or memory at an Internet storage, and/or memory in a central location, and any other desired memory. Thus, multiple copies of the electronic image may be stored in various memories. Although memory is relatively inexpensive, the electronic image may be compressed to reduce the need for memory capacity. However, it is desirable that the compression not be so significant that a reasonably accurate copy of the original paper receipt is lost. The memory is preferably organized or indexed so that given typical chargeback information such as the card number, amount, and date of purchase, the image can be recalled. Thus, a copy of the original receipt with the written endorsement of the purchaser, such as the purchaser's signature, can be retrieved. The copy may be viewed on screen 26, printed on printer 28, or mailed or emailed as indicated at 30. It will be appreciated that an embodiment of the invention shown in FIG. 1 can be implemented at very low cost and difficulty when using simple manual labor for scanning. As well, the invention may be more sophisticated and involve little or no manual. In a preferred embodiment, a copy of the complete original receipt is provided which is substantially identical to the copy of the receipt received by the purchaser. Thus, the merchant has excellent evidence readily available as a response to a chargeback request.

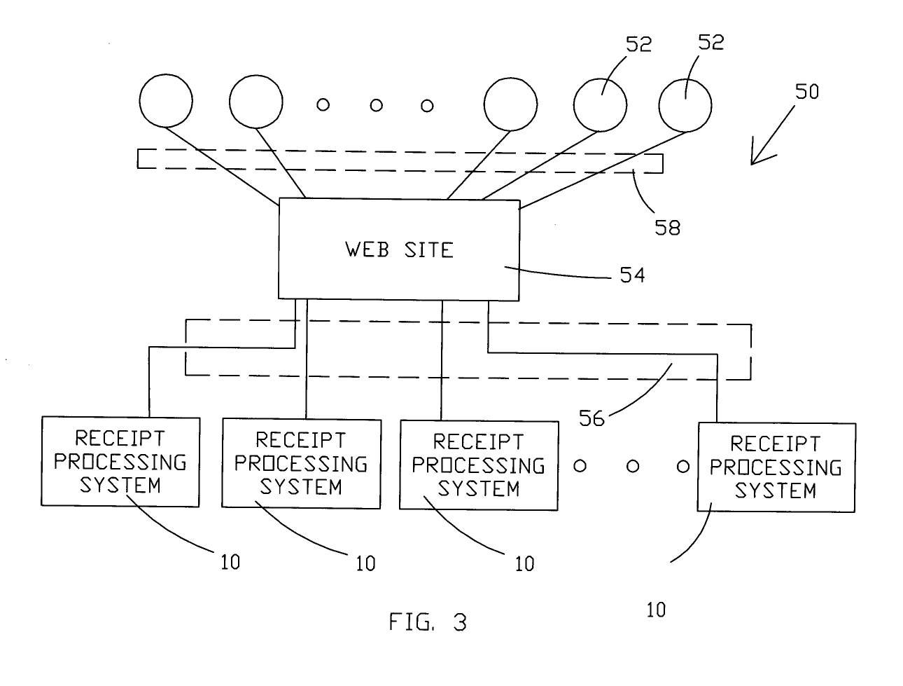

Referring now to FIG. 3, there is shown another embodiment of the invention which comprises system 50 which may be utilized by a plurality of purchasers or consumers 52 that may frequently eliminate the need by a purchaser, who previously had only his memory to rely on, to even instigate the chargeback process.

In this case, a plurality of systems 10 as shown may be interconnected such that the stored electronic copy of the original receipt is available to purchasers 52 from web site 54, such as the credit card issuer website. While it is desirable that system 10 be utilized to provide this information because of the preferred operation of storing a complete copy of the original receipt, other types of prior art systems that store only signatures associated with the relevant purchase data may also be utilized. Moreover, for online purchases where the purchaser has not actually made a signature, any endorsement information, such as passwords, special numbers on the credit card, bionic information, and the like, could be electronically associated with the purchase in memory to provide evidence of endorsement. In any case, the electronically stored receipt data, preferably including endorsement information, is transmitted through any number of connections or memories and transformed to a desired format for use by web site 54 through network 56. In one embodiment of the information, the underlying purchase data, which is already existent, may be made available through web site 54. Thus, system 50 may be utilized with or without system 10 or prior art signature capture information.

Credit card web sites permit purchasers or consumers 52 to connect through network connections 58, such as the Internet, to review what data is available, such as the date of the transaction and sometimes the location or store. In other cases, credit card companies send monthly statements that very briefly list each transaction and provide little information about the purchase. Thus, ticket data of system 50 may be merged with presently existing web sites to greatly enhance their usefulness and greatly reduce the costs associated with tracking underlying purchases. In accord with system 50, purchaser or consumer 52 could connect via a computer to web site or any other suitable location 54, or any other suitable location, and simply click the mouse on a transaction to pull up a duplicate of original receipt 14 shown in FIG. 2. It will be appreciated that this ability will greatly reduce the number of chargebacks presently presented. Large companies, such as the government, could even contract to have the receipt data automatically forwarded to the accounting department so that any time delays due to use of the network would be eliminated. Thus, for any charge, the accounting department could almost instantly review a copy of the underlying original receipt with endorsement of the authorized purchaser.

Thus, the present invention provides systems and methods of varying degrees of sophistication, from very simple to very complex, that may be utilized to retrieve a copy of an original receipt in order to avoid chargebacks due simply because the original paper receipt cannot be located. While the complete copy of the original receipt is preferred, system 10 may also be utilized to simply capture the signature or other endorsement.

System 50 may use information collected utilizing prior art systems discussed hereinbefore. However, system 10 is preferred because system 10 provides the most reliable information which includes an actual copy of the signed receipt so as to be less subject to after the fact manipulation. For online purchases, where no signature information is actually obtained, system 50 may also still be utilized to disclose any endorsement information that was given to show the transaction is valid. In a preferred embodiment, one or more systems 10 are utilized with system 50 or multiple systems 50, to provide underlying purchase data, such as a copy of the original receipt, to purchaser 52.

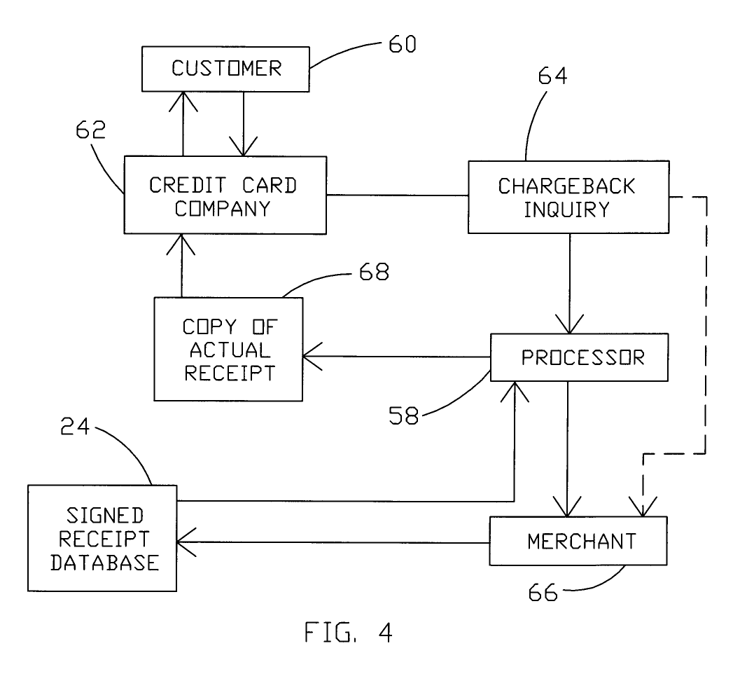

FIG. 4 discloses another preferred embodiment of the present invention whereby the merchant may be completely eliminated as the data provider for the chargeback inquiry process. In the example of FIG. 4, processor 58 has access to database 24, discussed hereinbefore which comprises copies of scanned and signed receipts which are organized based on indexes such as merchant number, purchase amount, credit card number, date, and the like. While processor 58 is shown as having access to database 24, any entity that receives the chargeback inquiry could be utilized to hand the chargeback inquiry in accord with the present invention. Thus, chargeback inquiry 64 is initiated when customer 60 questions a charge to credit card company 62. The chargeback inquiry is normally sent to merchant 66 and the processor 58. As discussed above, in many cases, perhaps as much as five percent of the time, the paperwork for the chargeback inquiry is lost at this point whereby merchant 66 is subject to having the charge reversed after the time period for response has lapsed. A single large company may lose millions annually simply due to lost chargeback inquiries. In accord with one embodiment of the invention, processor 58, which may also include other entities which have access to the chargeback inquiry request and signed receipt database 24, may simply retrieve the copy of the actual receipt 68 and send this to the credit card company 62, completely eliminating the need for merchant 66 to even respond to chargeback inquiries. Thus, the merchant may be able to eliminate a significant amount of overhead costs and reduce losses due to chargebacks.

The foregoing disclosure and description of the invention is therefore illustrative and explanatory of a presently preferred embodiment of the invention and variations thereof, and it will be appreciated by those skilled in the art, that various changes in the design, architecture, organization, order of operation, means of operation, equipment structures and locations, methodologies, the use of mechanical/electrical equivalents, as well as in the details of the illustrated construction or combinations of features of the various elements may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views. Thus, various changes and alternatives may be used that are contained within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. A method for processing a plurality of credit card financial transactions by a plurality of purchasers, comprising:
producing a plurality of paper receipts related to said plurality of credit card financial transactions such that each of said plurality of paper receipts comprise machine-readable data which identify each of said plurality of credit card financial transactions, each of said plurality of paper receipts comprise an endorsement by a respective of said plurality of purchasers to confirm each of said plurality of credit card financial transactions;
optically scanning each of said plurality of paper receipts for producing an electronic representation of said plurality of paper receipts including said endorsement and for reading said machine-readable data on said paper receipt; and
electronically storing said electronic copy of said paper receipt so as to be organized for electronic retrieval based on said machine-readable data.

2. The method of claim 1, wherein said machine-readable data comprises bar codes.

3. The method of claim 1, wherein said machine-readable data comprises textual print readable by optical character recognition (OCR) software.

4. The method of claim 1, further comprising providing credit card transaction information over the Internet to said plurality of purchasers, said credit card transaction information comprising said electronic copy of said paper receipt.

5. The method of claim 1, wherein said step of producing further comprises printing said paper receipt with a printer operable for providing said machine-readable data on said paper receipt.

6. The method of claim 1, wherein said endorsement comprises a signature.

7. A method for processing a plurality of credit card financial transactions by a plurality of purchasers, comprising:
producing a plurality of receipts related to said plurality of credit card financial transactions such that each of said plurality of receipts comprise an endorsement by a respective of said plurality of purchasers to confirm each of said plurality of credit card financial transactions;
electronically storing an electronic copy of each of said plurality of receipts, said electronic copy being suitable for producing a purchaser readable copy of a respective of said plurality of receipts; and
providing a web site on the Internet accessible by said plurality of purchasers or agents thereof, said web site providing credit card transaction information regarding transactions made by said plurality of purchasers during a selected time period, said web site being operable for providing a viewable copy of said respective of said plurality of receipts for a selectable credit card transaction.

8. The method of claim 7, wherein each of said plurality of receipts is a paper receipt.

9. The method of claim 8, wherein each of said plurality of paper receipts comprise financial transaction data comprising items purchased.

10. The method of claim 7, wherein said endorsement comprises a signature of each of said plurality of purchasers during a respective of said credit card financial transactions.

11. The method of claim 7, wherein said endorsement comprises a password known by a respective purchaser.

12. A method for processing a plurality of credit card financial transactions by a plurality of purchasers, comprising:
electronically storing receipt data related to said plurality of credit card financial transactions comprising underlying items purchased; and
providing a web site for use via Internet connection accessible by said plurality of purchasers or agents thereof, said web site providing credit card transaction information made by said plurality of purchasers during a selected time period, said web site being operable for providing a viewable copy of said receipt data for a selectable of said plurality of credit card transactions.

13. The method of claim 12, wherein receipt data comprises a paper receipt.

14. The method of claim 12, wherein said receipt data comprises a signature of each of said plurality of purchasers during a respective of said credit card financial transactions.

15. The method of claim 12, wherein said receipt data comprises a password known by a respective purchaser.

16. A system for processing a plurality of credit card financial transactions by a plurality of purchasers, comprising:
a printer operable for producing a paper receipt related to said plurality of credit card financial transactions such that each of said plurality of paper receipts comprise machine-readable data which identify each of said plurality of credit card financial transactions, each of said plurality of paper receipts being endorsed by a respective of said plurality of purchasers to confirm each of said plurality of credit card financial transactions;
an optical scanner for producing an electronic representation of said plurality of paper receipts including said endorsement, said optical scanner being operable for reading said machine-readable data on said paper receipt;
an electronic storage medium for storing said electronic representation of said paper receipt; and
a computer for organizing storage in said electronic storage based on said machine-readable data, said computer being operable for retrieving a selected electronic representation of said paper receipt based on said machine-readable data.

17. The system of claim 16, wherein said machine readable data comprises bar codes.

18. The system of claim 16, wherein said machine readable data comprises a respective credit card number, date of purchase, and amount of purchase.

19. The system of claim 18, wherein said machine-readable data comprises textual print readable by optical character recognition (OCR) software.

20. The system of claim 16, further comprising a website to provide credit card transaction information over the Internet to said plurality of purchasers, said credit card transaction information comprising said electronic copy of said paper receipt.

21. The system of claim 16, wherein said endorsement comprises a signature.

22. A system for processing credit card transactions, comprising:
a credit card company responsive to customer inquiries for issuing a chargeback inquiry into a selected purchase;
a merchant, said merchant producing sales;
an electronic database comprising electronic receipts of said sales;
a processor for receiving said chargeback inquiry, said processor being in communication with said database, whereupon said processor retrieves a copy of an electronic receipt for said selected purchase from said electronic database and forwards said copy of said electronic receipt to at least one of said credit card company or said customer.

23. The system of claim 22, wherein said merchant does not respond to said chargeback inquiry.

24. The system of claim 22, wherein each of said copies of said electronic receipts comprises a an electronic copy of a signed receipt.
